(19) United States
(12) Patent Application Publication
(10) Pub. No.: US 2015/0115875 A1
(43) Pub. Date: Apr. 30, 2015

(54) CHARGING CIRCUIT

(71) Applicants: YOKOGAWA ELECTRIC CORPORATION, Tokyo (JP); YOKOGAWA METERS & INSTRUMENTS CORPORATION, Tokyo (JP)

(72) Inventors: Masashi OOMIYA, Tokyo (JP); Moritoshi KOMAMAKI, Tokyo (JP)

(73) Assignees: YOKOGAWA ELECTRIC CORPORATION, Tokyo (JP); YOKOGAWA METERS & INSTRUMENTS CORPORATION, Tokyo (JP)

(21) Appl. No.: 14/520,629

(22) Filed: Oct. 22, 2014

(30) Foreign Application Priority Data
Oct. 25, 2013 (JP) 2013-222098

(51) Int. Cl. H02J 7/00

(52) U.S. Cl. CPC H02J 7/0072; H02J 7/0052
USPC 320/107

(57) ABSTRACT

A charging circuit for charging a rechargeable battery, the charging circuit includes: a switching element connected to a power supply; a pulse width controller configured to control open and close of the switching element; and a MOSFET arranged between the switching element and the rechargeable battery. The charging circuit may further include a thermistor connected between a gate and a source of the MOSFET.

### CROSS-REFERENCE TO RELATED APPLICATION

This application claims priority from Japanese Patent Application No. 2013-222098 filed with the Japan Patent Office on Oct. 25, 2013, the entire content of which is hereby incorporated by reference.

### BACKGROUND

1. Technical Field

The present disclosure relates to a charging circuit.

2. Related Art

FIG. 8 is a circuit diagram illustrating an example of the conventional step-down switching-type charging circuit. FIG. 9 is a diagram illustrating an example of a charging control of a lithium ion battery.

As illustrated in FIG. 8, a switching element SW, an inductor L, a current detection resistor Rs, and the positive terminal of a battery pack BPK including, for example, a lithium ion battery are connected in series to the positive terminal of a DC power supply Vin. The negative terminal of the battery pack BPK is connected to the negative terminal of the DC power supply Vin.

The cathode of a diode D is connected to the connection node of the switching element SW and the inductor L. One terminal of a capacitor C is connected to the connection node of the inductor L and the current detection resistor Rs. The anode of the diode D and the other terminal of the capacitor C are connected to the negative terminals of the DC power supply Vin and the battery pack BPK. That is, the diode D and the capacitor C are connected in parallel to the DC power supply Vin and the battery pack BPK. It is noted that the voltage between both terminals of the current detection resistor Rs is inputted to a Pulse Width Modulation (PWM) control unit CTL.

According to the above, the PWM control unit CTL is able to detect the state of a charge voltage A′ and a charge current Ic. The PWM control unit CTL controls the charging of the battery pack BPK as illustrated in FIG. 9 by PWM-controlling the turning on and off of the switching element SW based on these detected results.

In FIG. 9, the vertical axis represents the voltage value and the current value, and the horizontal axis represents the charge time. The characteristic A represents the charge voltage A′ and the characteristic B represents the charge current Ic.

Under the state where the charge voltage A′ does not reach a specified value (the battery voltage of the battery pack BPK is low), such a control is made that the voltage difference between both terminals of the current detection resistor Rs is maintained constant. That is, the charge current Ic flowing in the current detection resistor Rs is maintained constant. Therefore, the battery pack BPK is charged at a constant current.

In response that the charge voltage A′ reaches the specified value (the upper limit of the charge voltage), since no current flows in the battery pack BPK, the current value of the charge current Ic gradually decreases. At this time, the charge voltage is in a constant voltage control so as to be maintained constant at an upper limit of the specified voltage. Thereby, the battery pack BPK is charged at a constant voltage.

In the battery pack and the charging system disclosed in JP-A-2009-123560, the constant voltage charging circuit or the constant current and constant voltage charging circuit is utilized. Furthermore, these battery pack and charging system reduce the concern that the terminal voltage of the rechargeable battery exceeds the tolerance voltage range.

### SUMMARY

A charging circuit for charging a rechargeable battery includes: a switching element connected to a power supply; a pulse width controller configured to control open and close of the switching element; and a MOSFET arranged between the switching element and the rechargeable battery.

### BRIEF DESCRIPTION OF DRAWINGS

FIG. 1 is a circuit diagram illustrating one embodiment of the present disclosure;

FIG. 2 is a characteristic diagram illustrating a relationship between the on-resistance and the temperature;

FIG. 3 is a circuit diagram illustrating a main part of another embodiment of the present disclosure;

FIG. 4 is a diagram illustrating an example of a change characteristic of the on-resistance to the temperature in the circuit of FIG. 3;

FIG. 5 is a circuit diagram illustrating a main part of another embodiment of the present disclosure;

FIG. 6A is a characteristic example diagram illustrating a relationship between an output voltage of an operational amplifier and a load current, and FIG. 6B is a characteristic example diagram illustrating a relationship between the output voltage and the on-resistance;

FIG. 7 is a circuit diagram illustrating a main part of another embodiment of the present disclosure;

FIG. 8 is circuit diagram illustrating an example of the conventional step-down switching-type charging circuit; and

FIG. 9 is a diagram illustrating an example of a charging control of a lithium ion battery.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In the conventional charging circuit, the current detection resistor Rs that is a fixed resistor is used to detect the charge current. This makes it difficult to apply the optimum charging while changing the charge current. For example, the current in the charging is maintained constant regardless of whether the equipment is operating or the operation thereof is suspended. Therefore, the measuring equipment and the like that is susceptible to the rise and change in the temperature is affected by the rise in the temperature due to the charging. Thus, the maximum performance of the equipment cannot be derived.

Further, as an AC adaptor for supplying power, the AC adaptor configured to output the power which is the sum of the power for the charging and the power for the operation of the equipment is prepared. It is therefore difficult to unify the AC adaptor for every equipment. Furthermore, the rated value of the AC adaptor becomes larger. Thus, the conventional charging circuit is uneconomical in terms of the cost and the consumption power.

One of the purposes of the present disclosure is to provide a charging circuit that is able to stabilize the temperature change inside the equipment (or the temperature inside the equipment) and to perform effective charging by a proper value of the charge current depending on the operation state of the equipment. In this charging circuit, as a current detection element, an element having a resistance that changes electrically or changes in response to the temperature change is used in place of the fixed resistor. For example, based on the current flowing in this element, the open and close of the switching element is PWM-controlled.

A charging circuit for charging a rechargeable battery according to a first embodiment of the present disclosure includes: a switching element connected to a power supply; a pulse width controller configured to control open and close of the switching element; and a MOSFET arranged between the switching element and the rechargeable battery.

The charging circuit according to a second embodiment of the present disclosure further includes a thermistor connected between a gate and a source of the MOSFET, in the charging circuit according to the first embodiment.

The charging circuit according to a third embodiment of the present disclosure further includes a voltage control unit configured to control a gate to source voltage of the MOSFET, in the charging circuit according to the first or second embodiment.

The charging circuit according to a fourth embodiment of the present disclosure further includes a load, in the charging circuit according to the third embodiment. The voltage control unit is configured to reduce the gate to source voltage of the MOSFET when a load current supplied to the load is larger, while to increase the gate to source voltage of the MOSFET when the load current is smaller.

In the charging circuit of a fifth embodiment of the present disclosure, the voltage control unit includes a plurality of load circuits having different voltage values, and the plurality of load circuits is configured to be selectively connected to a gate of the MOSFET, in the charging circuit according to the third embodiment.

The above allows for implementing the charging circuit that is able to stabilize the temperature change inside the equipment (or the temperature inside the equipment) and to perform effective charging by the proper value of the charge current depending on the operation state of the equipment.

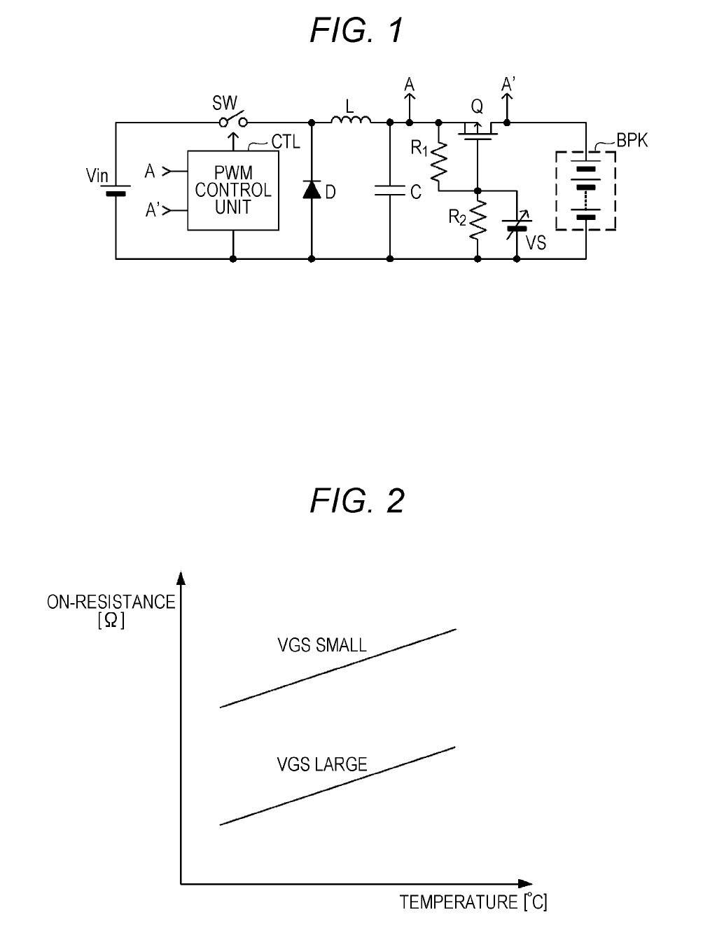

The present disclosure will be described below in detail by using the drawings. FIG. 1 is a circuit diagram illustrating a charging circuit according to one embodiment of the present disclosure. This charging circuit is a step-down switching-type charging circuit. As illustrated in FIG. 1, a switching element SW, an inductor L, a P-channel field effect transistor (MOSFET) Q, and the positive terminal of a battery pack BPK including, for example, a lithium ion battery (a rechargeable battery) are connected in series to the positive terminal of a DC power supply Vin. The negative terminal of the battery pack BPK is connected to the negative terminal of the DC power supply Vin. As such, this charging circuit has the P-channel field effect transistor Q (MOSFET) for detecting the charge current. In this charging circuit, a positive temperature characteristic provided by the on-resistance of the field effect transistor Q is utilized.

A resistor R₁ is connected between the gate and the source of the field effect transistor Q. The gate of the field effect transistor Q is connected to the negative terminals of the DC power supply Vin and the battery pack BPK via a parallel circuit including a resistor R₂ and a variable power supply (a voltage control unit) VS.

The cathode of a diode D is connected to the connection node of the switching element SW and the inductor L. One terminal of a capacitor C is connected to the connection node of the inductor L and the source of the field effect transistor Q. The anode of the diode D and the other terminal of the capacitor C are connected to the negative terminals of the DC power supply Vin and the battery pack BPK. That is, the diode D and the capacitor C are connected in parallel to the DC power supply Vin and the battery pack BPK.

A PWM control unit (a pulse width controller) CTL outputs the pulse width control signal to the switching element SW to control the open and close (turning on and off) of the switching element SW. The voltage between the source and the drain of the field effect transistor Q is inputted to the PWM (Pulse Width Modulation) control unit CTL. Thereby, the PWM control unit CTL is able to detect the charge voltage A′ and the charge current. The PWM control unit CTL controls the charging of the battery pack BPK by, for example, PWM-controlling the turning on and off of the switching element SW based on these detected results.

In the above configuration, the on-resistance of the field effect transistor Q is used as a charge current detection resistor. This allows for applying a temperature modulation to the charge current. That is, the rise in the temperature inside the equipment causes the on-resistance to increase and therefore the charge current decreases. On the other hand, the fall in the temperature inside the equipment causes the charge current to increase. This operation cycle causes the temperature change inside the equipment (or the temperature inside the equipment) during the operation of the equipment to be averaged. This allows for reducing the affection of the temperature change to the operation of the equipment such as precision measuring instrument and the like that is susceptible to the temperature change.

Further, the change in the on-resistance depending on the change in the gate to source voltage Vgs of the field effect transistor Q is utilized to suppress the rise in the temperature due to the charging during the operation of the equipment. The on-resistance of the field effect transistor Q has such a characteristic that the on-resistance becomes larger when the potential difference between the gate and the source is smaller, while becomes smaller when this potential difference is larger, as well known.

FIG. 2 is a characteristic diagram representing the relationship between the on-resistance and the temperature. In this charging circuit, the characteristic represented in this figure is used. That is, when the equipment is operating (when the current (the load current) supplied to the equipment is larger), a smaller Vgs is applied by the variable power supply VS of FIG. 1 to increase the on-resistance and reduce the charge current. On the other hand, when the operation of the equipment is suspended (when the current (the load current) supplied to the equipment is smaller), a larger Vgs is applied to reduce the on-resistance and increase the charge current. This operation suppresses the rise in the temperature due to the charging during the operation of the equipment, while increases the charge current to shorten the charge time when the operation of the equipment is suspended. The reduction of the affection by the temperature change and the shortening of the charge time can be achieved, for example, at the same time. In this way, the variable power supply VS is configured to control the gate to source voltage of the field effect transistor Q.

Here, when the similar control is performed by switching the conventional fixed resistor by, for example, a switch and the like, the resistance is not changed continuously and thus there is a concern that an unstable period occurs due to the transient response. In the present embodiment, however, the change of the on-resistance of the field effect transistor Q is continuous. Therefore, the present embodiment does not substantially have the element that makes the control of the charging circuit unstable. Thus, according to the present embodiment, the stable operation can be obtained.

According to the above configuration, the positive temperature characteristic provided by the on-resistance of the field effect transistor Q is utilized to apply the temperature modulation to the charge current. This allows for stabilizing the temperature change inside the equipment (or the temperature inside the equipment) and for deriving the performance of the equipment to the maximum.

Further, the change in the on-resistance of the field effect transistor Q is utilized to cause the charge current to be significantly variable, so that the rise in temperature and the consumption power can be reduced by applying the charging at the minimum current during the operation of the equipment and, on the other hand, the charge time can be shortened by applying the charging at the maximum current during the suspension of the operation of the equipment. Further, the AC adaptor having a small output capacity can be selected as the AC adaptor to be used. Therefore, the electrical and financial, economic efficiency can be improved.

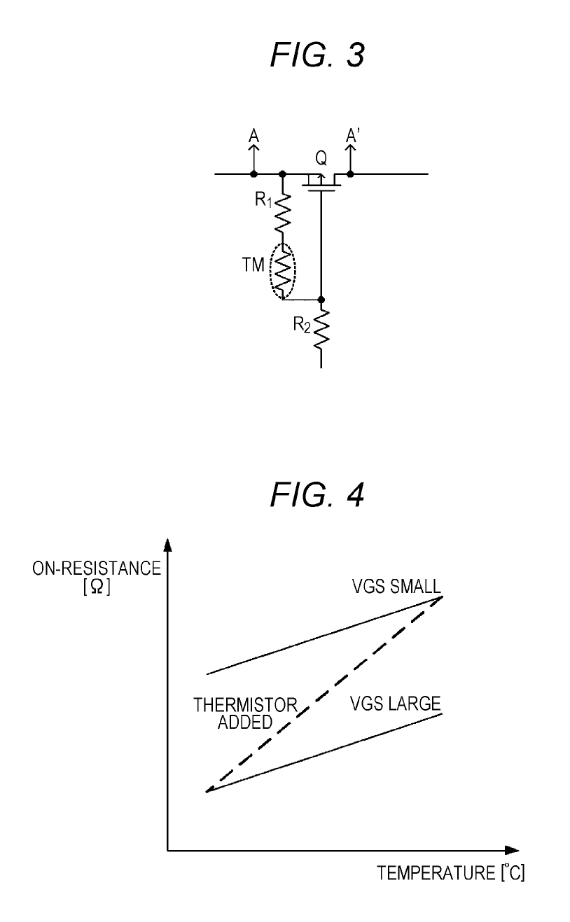

FIG. 3 is a circuit diagram illustrating the main part of another embodiment of the present disclosure. In FIG. 3, the same reference numerals are provided to the parts common to FIG. 1. In the embodiment circuit of FIG. 3, a thermistor TM is connected between the gate and the source of the field effect transistor Q.

FIG. 4 illustrates an example of the change characteristic of the on-resistance to the temperature in the circuit of FIG. 3. Addition of the thermistor TM as illustrated in FIG. 3 allows for a larger change rate of the on-resistance to the temperature as illustrated by the dotted line in FIG. 4. Thus, the change amount of the charge current to the temperature can be increased, which facilitates an easier adjustment to a desired control characteristic. It is noted that the similar result can be obtained by controlling the variable power supply VS of FIG. 1 based on the temperature change.

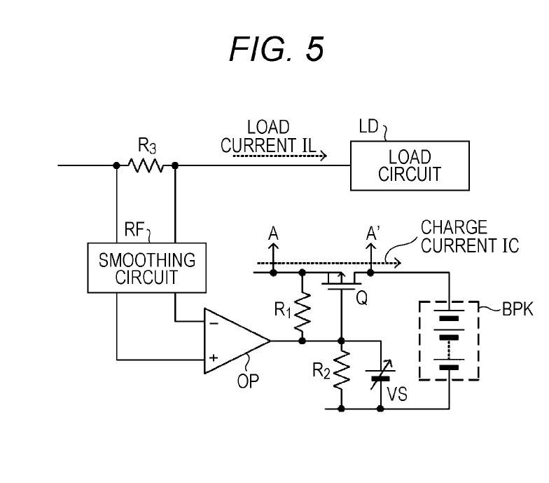

FIG. 5 is a circuit diagram illustrating the main part of another embodiment of the present disclosure. In FIG. 5, the same reference numerals are provided to the parts common to FIG. 1. In the embodiment circuit of FIG. 5, the load current IL flowing in a load circuit LD is detected as a voltage value by a detection resistor R₃ and, after being smoothed by a smoothing circuit RF, is inputted to the gate of the field effect transistor Q via an operational amplifier (a voltage control unit) OP.

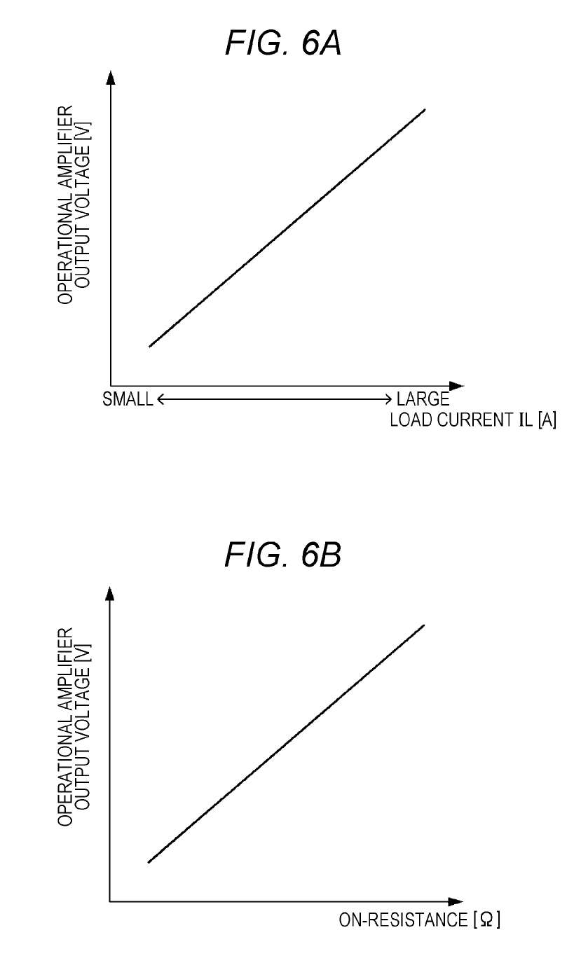

Thereby, as illustrated in FIG. 6A and FIG. 6B, the on-resistance of the field effect transistor Q is controlled based on the output voltage of the operational amplifier OP. When the current flowing in the load circuit LD is smaller, the output voltage of the operational amplifier OP becomes smaller. Thereby, the Vgs increases (the on-resistance decreases) and the charge current increases. In contrast, when the current flowing in the load circuit LD is larger, the output voltage of the operational amplifier OP becomes larger. Thereby, the Vgs decreases (the on-resistance increases) and the charge current decreases. FIG. 6A is a characteristic example diagram illustrating the relationship between the output voltage of the operational amplifier OP and the load current IL. FIG. 6B is a characteristic example diagram illustrating the relationship between the output voltage of the operational amplifier OP and the on-resistance. In this way, the operational amplifier OP is configured to control the gate to source voltage of the field effect transistor Q.

As discussed above, the control such that the consumption power in the entire equipment is maintained constant allows the heat generation to be averaged. As a result, the consumption power which matches the rated value of the AC adaptor can be achieved. It is noted that the charging circuit of FIG. 5 may include the thermistor TM illustrated in FIG. 3.

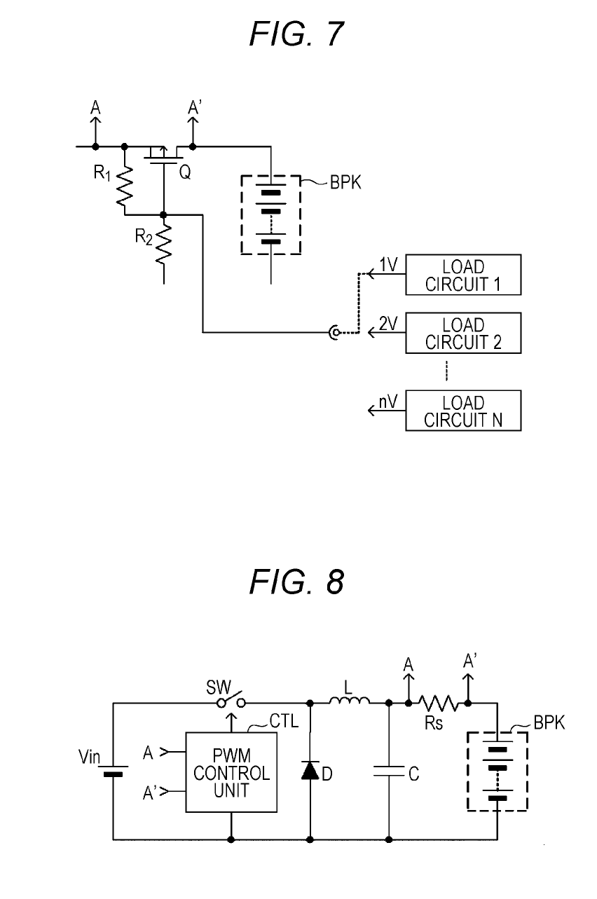

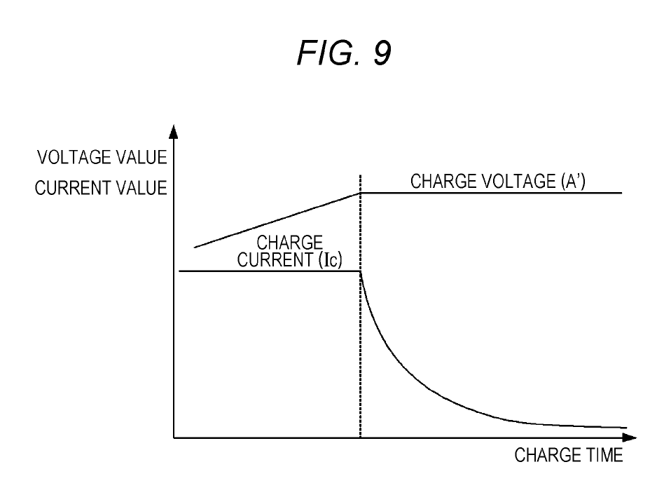

FIG. 7 is a circuit diagram illustrating the main part of another embodiment of the present disclosure. In FIG. 7, the same reference numerals are provided to the parts common to FIG. 1. The embodiment circuit of FIG. 7 is configured to be able to selectively connect a plurality of load circuits (voltage control units) having the different voltage values to the gate of the field effect transistor Q, and configured to charge the battery pack BPK.

For example, it is assumed that the voltage value of a load circuit 1 is set to 1 V, the voltage value of a load circuit 2 is set to 2 V, and the voltage value of a load circuit n is set to n V. Any of these load circuits is mechanically or electrically connected to the charging circuit, thereby a predetermined voltage value that is set for the load circuit is applied to the gate of the field effect transistor Q of the charging circuit. The Vgs of the field effect transistor Q is changed by this predetermined voltage value and thereby the on-resistance of the field effect transistor Q changes. As a result, the battery pack BPK can be charged at the optimal charge current corresponding to each of the load circuits. In this way, the plurality of load circuits is configured to control the gate to source voltage of the field effect transistor Q. It is noted that the charging circuit of FIG. 7 may include the thermistor TM illustrated in FIG. 3.

As described above, the embodiments of the present disclosure allow for implementing the charging circuit that is able to stabilize the temperature change inside the equipment (or the temperature inside the equipment) and to perform the effective charge by the proper value of the charge current depending on the operation state of the equipment.

Further, the charging circuit according to one embodiment of the present disclosure may be the following first to fifth charging circuits. The first charging circuit is a step-down switching-type charging circuit configured to charge a rechargeable battery via a switching element controlled to be opened and closed by a pulse width control signal outputted from pulse width control means and via charge current detection means, in which the charge current detection means is a MOSFET.

In the second charging circuit in the first charging circuit, a thermistor is connected between a gate and a source of the MOSFET.

The third charging circuit in the first or second charging circuit further has load current detection means for detecting magnitude of a load current supplied to a load and, according to the magnitude of the load current, controls the magnitude of the charge current so that consumption power of entire equipment is maintained constant.

The fourth charging circuit is configured to be selectively connected to a plurality of load circuits having different voltage values, and performs charging at an optimum charge current corresponding to a connected load circuit.

The fifth charging circuit includes a switching element connected to a power supply, a MOSFET arranged between the switching element and a rechargeable battery, and a pulse width controller configured to detect a charge current flowing in the MOSFET for charging the rechargeable battery and control open and close of the switching element based on the detected charge current.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A charging circuit for charging a rechargeable battery, the charging circuit comprising:
a switching element connected to a power supply;
a pulse width controller configured to control open and close of the switching element; and
a MOSFET arranged between the switching element and the rechargeable battery.

2. The charging circuit according to claim 1 further comprising a thermistor connected between a gate and a source of the MOSFET.

3. The charging circuit according to claim 1 further comprising a voltage control unit configured to control a gate to source voltage of the MOSFET.

4. The charging circuit according to claim 2 further comprising a voltage control unit configured to control a gate to source voltage of the MOSFET.

5. The charging circuit according to claim 3 further comprising a load,
wherein the voltage control unit is configured to reduce the gate to source voltage of the MOSFET when a load current supplied to the load is larger, while to increase the gate to source voltage of the MOSFET when the load current is smaller.

6. The charging circuit according to claim 4 further comprising a load,
wherein the voltage control unit is configured to reduce the gate to source voltage of the MOSFET when a load current supplied to the load is larger, while to increase the gate to source voltage of the MOSFET when the load current is smaller.

7. The charging circuit according to claim 3,
wherein the voltage control unit includes a plurality of load circuits having different voltage values, and
the plurality of load circuits is configured to be selectively connected to a gate of the MOSFET.

8. The charging circuit according to claim 3,
wherein the voltage control unit includes a plurality of load circuits having different voltage values, and
the plurality of load circuits is configured to be selectively connected to a gate of the MOSFET.
